(19) United States
(12) Patent Application Publication
(10) Pub. No.: US 2011/0203700 A1
(43) Pub. Date: Aug. 25, 2011

(54) INTERFACING AN INLET TO A CAPILLARY CHANNEL OF A MICROFLUIDIC SYSTEM

(75) Inventors: Monica Scholten, Eindhoven (NL); Joost Hubert Maas, Eindhoven (NL); Godefridus Johannes Verhoeckx, Eindhoven (NL); Maurice Hubert Elisabeth Van Der Beek, Eindhoven (NL)

(73) Assignee: KONINKLIJKE PHILIPS ELECTRONICS N.V., EINDHOVEN (NL)

(21) Appl. No.: 13/127,167

(22) PCT Filed: Nov. 10, 2009
(86) PCT No.: PCT/IB09/54986

§ 371 Date: May 2, 2011

(30) Foreign Application Priority Data
Nov. 13, 2008 (EP) 08168980.4

(51) Int. Cl. B65B 3/04; B01L 3/00

(52) U.S. Cl. 141/2; 422/507

(57) ABSTRACT

The invention relates to microfluidic systems, and more specifically to a microfluidic system comprising a capillary channel (14) and an inlet (12) for receiving a fluid, as well as a method of filling a capillary channel (14). Provided is a microfluidic system, having an inlet (12) for receiving a fluid, a capillary channel (14), an outlet (20) for letting excess fluid out, and a reservoir (10) for interfacing the inlet (12) to the capillary channel (14). The reservoir (10) forms a first passage from the inlet (12) to the outlet (20), and a second passage from the inlet (12) to an entrance (22) of the capillary channel (14). A hydraulic resistance of the first passage is sufficiently low in order to effect a pressure reduction at the entrance (22) of the capillary channel (14) when a fluid is received under pressure at the inlet (12).

### FIELD OF THE INVENTION

The invention relates to the field of micro fluidic systems, and more specifically to a microfluidic system comprising a capillary channel and an inlet for receiving a fluid.

### BACKGROUND OF THE INVENTION

Significant advancements in the fields of chemistry and technology have been made due to the use of microfluidic technology.

The term “microfluidic” is generally used to refer to a system or device having channels and chambers that are fabricated with at least one cross-sectional dimension, such as a depth, a width, or a diameter, of less than a millimeter. For example, microfluidic channels and chambers form fluid channel networks that allow the transportation, mixing, separation and/or detection of very small quantities of materials. Microfluidic devices are particularly advantageous, because they make it possible to perform various measurements, such as chemical, optical, etc. measurements, with small sample sizes and in automatable high-throughput processes.

Because of the small channel size and fluid volumes used in microfluidic devices, there are factors that influence fluid flow within micro fluidic devices that are less important in fluid flow on a larger scale. For example, physical properties of fluids such as surface tension, viscosity, etc. can have a much greater impact on fluid mechanics than these properties have in macro-scale flows.

From US 2005/0133101A1, a microfluidic system is known having an inlet storage chamber for storing a fluid injected from outside. A flow channel connects the storage chamber to a reaction chamber. A driving force necessary for moving the fluid occurs from a natural capillary phenomenon, so that it does not require an external driving force.

### SUMMARY OF THE INVENTION

In a microfluidic device, it is generally desirable that the device fills with liquid autonomously, i.e., the rate of filling is completely or at least mainly determined by the properties of the device and the fluid, e.g. a sample liquid. It is desirable that the rate of filling cannot be influenced by a user once the filling process is triggered.

For example, when using a microfluidic analytical device, typically, samples are first acquired in volumes, which are far greater than, and incompatible with, the scale of the microfluidic analytical device. For example, a sample fluid may be acquired in a front-end unit or module of a micro fluidic system, which, for example, may be pressure driven.

It would be desirable to eliminate interfacial phenomena related to the connection of the pressure driven part and a capillary driven part of the micro fluidic system. It would also be desirable to decouple a capillary driven part of the microfluidic device from a pressure imposed on a fluid, which is to be introduced into the capillary part. It would also be desirable to achieve a microfluidic system having an inlet for receiving a fluid under pressure and having a capillary channel, which fills with fluid autonomously.

To better address one or more of these concerns, in a first aspect of the invention, a micro fluidic system is provided that comprises:

an inlet for receiving a fluid,

a capillary channel,

an outlet for letting excess fluid out, and

a reservoir for interfacing the inlet to the capillary channel,

wherein the reservoir forms a first passage from the inlet to the outlet,

wherein the reservoir forms a second passage from the inlet to an entrance of the capillary channel, and

wherein a hydraulic resistance of the first passage is sufficiently low in order to effect a pressure reduction at the entrance of the capillary channel when a fluid is received under pressure at the inlet.

The reducing of the pressure is achieved by the structure of the reservoir. In particular, the pressure is reduced without active pressure reducing means.

The hydraulic resistance a pressure driven fluid flow experiences is the pressure difference divided by the flow rate, i.e. R_{hydr}=ΔP/Φ. The unit of the hydraulic resistance is Pa s/m³. Given the properties of the fluid, the hydraulic resistance is fully dependent on geometric parameters of the reservoir or the capillary channel, respectively. For example, the hydraulic resistance of a reservoir passage or, in general, a channel, with a rectangular cross-section is approximately:

R_{hydr}=12ηL/h³w(1−0.63(h/w)),

where η is the dynamic viscosity of the fluid, L the length of the channel, h the channel height, and w the channel width, h being less than or equal w.

Thus, in general, a sufficiently low hydraulic resistance is achievable by a sufficiently large cross-section of the respective passage or channel.

The term “cross-section” means the cross-sectional area. This cross-sectional area is the area that may be filled by the fluid, that is, in particular, the maximum available area for fluid flow along the respective passage or channel. This area may be continuous in a given cross-sectional plane, or it may consist of two or more separate parts. For example, when the reservoir is filled with a porous filter material, the cross-section is reduced due to the fluid displacement of the filter material. Furthermore, the cross-sectional area may be parted due to the filter material forming internal walls of the reservoir.

Since the hydraulic resistance of the reservoir along the first passage depends on the size and geometric shape of the cross-section along the first passage, the dimensions have to be chosen dependent on the geometric shape of the cross-section. By adequately choosing the dimensions of the reservoir, in particular by choosing the dimensions of the first passage of the reservoir with respect to that of the capillary channel and/or the second passage, for example, any pressure driven fluid flow that fills the reservoir from the inlet can be prevented from entering the capillary channel. For example, because of the negligible resistance of the reservoir with respect to the resistance of the capillary channel, the fluid will simply flow past rather than fill the capillary channel. Any fluid surplus is made to leave the reservoir via the outlet. Thus, due to the sufficiently low hydraulic resistance of the first passage or, in particular, said part of the first passage, which is upstream of a common part of the first and second passages, a pressure reduction is provided at the entrance of the capillary channel. Thus, the capillary channel may be filled autonomously. The term “filling the capillary channel” means filling the capillary channel completely or at least up to a defined limit, e.g. a position of a microfluidic device.

The progression of the hydraulic resistance of the reservoir along the first passage may vary locally and, for example, is not necessarily linear. For example, at least in one or more parts of the first passage, the hydraulic resistance of the respective parts may be sufficiently low, so that the overall effect of the hydraulic resistance is to provide the pressure reduction at the entrance of the capillary channel. For example, the cross-section of the first passage varies in its course from the inlet to the outlet. That is, the profile of the cross-section is not constant along the first passage. For example, at least in one or more parts of the first passage, the cross-section is sufficiently large, so that in total, the effect of the cross-section, which varies along the first passage, is to provide the sufficiently low hydraulic resistance, and, thus, the pressure reduction at the entrance of the capillary channel.

For example, the first passage, in its course from the inlet to the outlet, has a profile of the cross-section, which is sufficiently large in order to provide a pressure reduction at the entrance of the capillary channel when a fluid is received under pressure at the inlet. This implies that the hydraulic resistance of the first passage is sufficiently low. In particular, the first passage may have a profile of the cross-section, which is, in the course of the first passage from the inlet to the outlet, at least locally sufficiently large in order to provide the pressure reduction at the entrance of the capillary channel when a fluid is received under pressure at the inlet.

For example, the capillary channel is a capillary channel for transporting fluid by capillary force. For example, the microfluidic system comprises a microfluidic device. For example, the capillary channel is a capillary channel for transporting fluid to a microfluidic device of the microfluidic system.

For example, the inlet is an inlet for receiving a fluid under pressure. Due to the pressure reduction or even pressure decoupling, a pressure driven administering of sample fluid to the microfluidic system has a negligible influence on the filling of the capillary channel. Furthermore, the filling is not dependent on the orientation of the microfluidic system, and, thus, e.g. of a hand-held device comprising the microfluidic system.

The outlet is, for example, an escape vent. For example, the outlet is open to the outside.

For example, the second passage has at least an upstream part in common with the first passage. That is, the first passage partly or fully comprises the second passage. For example, in the course of the first passage from the inlet to the outlet, a downstream part of the second passage may branch off.

Below, several examples of the constructive design of the reservoir having a hydraulic resistance of the first passage, which is sufficiently low, will be explained.

For example, a hydraulic resistance of that part of the first passage, which is downstream of the entrance of the capillary channel and/or downstream of a common part of the first and second passages, may be sufficiently low in order to provide a pressure reduction at the upstream end of this part of the first passage, and, thus, at the entrance of the capillary channel. For example, the entrance of the capillary channel may be arranged at the downstream end of said common part of the first and second passages, or the first and second passages may branch downstream of the common part of the passages. In both cases, the pressure at the entrance of the capillary channel will be equal to or less than the pressure at the downstream end of the common part of the passages. A sufficiently low hydraulic resistance may be achievable by a sufficiently large cross-section profile.

Additionally and/or alternatively, a part of the second passage branching off from the first passage downstream of a common part of the passages may have a certain hydraulic resistance which, e.g., is higher than a hydraulic resistance of the common part of the passages and/or that part of the first passage which is downstream of the common part of the passages. Then, the hydraulic resistance of the first passage, in particular in said downstream part of the first passage, will be sufficiently low to enable said part of the second passage, which is downstream of the common part of the passages, to provide the pressure reduction at the entrance of the capillary channel. Also, a somewhat higher hydraulic resistance of that part of the first passage downstream of the common part of the passages may still be sufficiently low in order to provide the required pressure reduction at the entrance of the capillary channel.

The term “pressure reduction” may include a pressure decoupling, that is, a reduction of pressure such that an unpressurized fluid is provided at the entrance of the capillary channel.

For example, the pressure reduction is a pressure reduction for preventing a fluid from entering the capillary channel under pressure.

The pressure reduction or decoupling makes an autonomous filling of the capillary channel is possible. Fluid entering the reservoir under pressure will flow past the channel entrance towards the outlet rather than be forced to enter the channel.

Thus, the reservoir may be a pressure reduction chamber, e.g. a pressure decoupling chamber, for providing an unpressurized fluid at the entrance of the capillary channel when the fluid is received under pressure at the inlet.

For example, the first and/or the second passage of the reservoir are not a microfluidic passage. In particular, said passage may have cross-sectional dimensions larger than a millimeter in each direction. Thus, for example, the reservoir may hold a large quantity of fluid for being provided to at least one capillary channel.

Useful details of the invention are indicated in the dependent claims.

In one embodiment, a hydraulic resistance of the first passage is lower than a hydraulic resistance of the second passage and the capillary channel. For example, in particular, a hydraulic resistance of that part of the first passage, which is upstream of a common part of the first and second passages, is lower than a hydraulic resistance of that part of the second passage, which is upstream of the common part of the first and second passages, and/or the capillary channel. For example, a hydraulic resistance of the first passage is lower than a hydraulic resistance of that part of the second passage, which is upstream of the common part of the first and second passages, and/or the capillary channel.

For example, the inlet is arranged upstream of the entrance to the capillary channel and the outlet is arranged downstream from the entrance of the capillary channel. For example, the capillary channel branches from the first passage of the reservoir. For example, the first passage from the inlet to the outlet comprises a part of the reservoir which extends from upstream of the entrance to the outlet and which has a lower hydraulic resistance and/or a larger cross-section than the capillary channel.

For example, the outlet has a larger cross-section than the entrance of the capillary channel.

In one embodiment, the pressure reduction allows the capillary channel to be filled substantially by capillary forces. In particular, the pressure reduction may allow the capillary channel to be filled mainly by capillary forces or by capillary forces only. Thus, the capillary channel is decoupled from pressure applied to the fluid inlet.

For example, the microfluidic system further comprises a microfluidic device, wherein the capillary channel is arranged for transporting a fluid to the microfluidic device. For example, the capillary channel is arranged for transporting a fluid by capillary force. Thus, an autonomous filling of the capillary channel and transporting of the fluid is provided. Transporting of a fluid by capillary force depends solely on the properties of the channel and the sample fluid and, therefore, is a very robust way to achieve autonomous filling. An extra actuation or pumping device can be dispensed with. In general, the microfluidic system may comprise more than one capillary channel and may comprise more than one microfluidic device per capillary channel. The capillary channel or channels may form an input for a microfluidic network including one or more microfluidic devices.

In one embodiment, the entrance of the capillary channel is wettable by a fluid from a common part of the first and second passages. For example, the entrance of the capillary channel is arranged at the reservoir for being wetted by fluid flowing through the first passage and/or filling the first passage. In particular, the entrance of the capillary channel may be wettable by an unpressurized fluid from the reservoir, in particular from the common part of the first and second passages. That is, no pressure is required for wetting the entrance of the capillary channel. For example, when the common part of the first and second passages is filled with the fluid, the remaining upstream part of the second passage may be wettable by the fluid. Thus, the fluid may be transported from the common part of the first and second passages to the entrance of the capillary channel by wetting.

In one embodiment, the entrance of the capillary channel is wettable without pressure by fluid present in that part of the second passage, which is upstream of a common part of the first and second passages and/or upstream of the inlet. In particular, there is no wetting barrier at the entrance of the capillary channel. Thus, the capillary channel may be autonomously filled by an unpressurized fluid.

In one embodiment, an inner surface area of the reservoir, which surrounds and forms the entrance of the capillary channel, has a substantially uniform wettability. For example, walls of the reservoir, which continuously extend along the second passage, are substantially uniformly wettable along the second passage and including said inner surface area. Thus, an unpressurized liquid fluid reaching the inner surface area surrounding the entrance of the capillary channel may autonomously wet the entrance of the capillary channel and enter the capillary channel by capillary force.

In one embodiment, a filter material separates a first passage from the entrance of the capillary channel. Thus, at least a part of the second passage runs through the filter material. That is, a part of the second passage distinct from the first passage is formed by a filter material. The filter material reduces the cross-section of said part of the second passage. Furthermore, a filter material may enhance the wettability of said part of the second passage. For example, the filter material may be arranged to transport a fluid by wetting in the direction of the entrance of the capillary channel. For example, a first part of the reservoir may form the first passage, and the second part of the reservoir may contain the filter material and may form a part of the second passage, which is upstream of the common part of the first and second passages. Filter material may also be present in the first passage, in particular, in the common part of the first and second passages. The filter material may be formed integral with walls of the reservoir.

For example, the filter material separating the first passage from the entrance of the capillary channel increases the hydraulic resistance of the second passage. For example, the absence of filter material in a part of the first passage downstream of the common part of the first and second passages may render the hydraulic resistance of the first passage sufficiently low in order to effect said pressure reduction at the entrance of the capillary channel. Moreover, a filter material separating the first passage from the entrance of the capillary channel may prevent bubbles contained in the fluid from reaching the entrance of the capillary channel.

In one embodiment, the first passage is passable by bubbles contained in the fluid. Thus, air bubbles present in the fluid may be removed through the outlet. This facilitates the supply of fluid to the capillary channel.

In one embodiment, a common part of the first and second passages comprises a passive pressure valve. The term “passive pressure valve” describes a part of a passage that requires a certain level of pressure in order to be flooded by the fluid. After the passive pressure valve has been flooded, its contribution to the hydraulic resistance may be negligible. The passive pressure valve may ensure that an adequate minimum amount of fluid is present, for example, in a front-end unit arranged to deliver the fluid through the inlet to the reservoir, before an autonomous filling of the capillary channel is triggered. Thus, within certain limits, the autonomous filling of the capillary channel will not depend on the quantity of a sample fluid, for example, or on the rate of a user's actions. For example, the front-end unit of the microfluidic system may be a sample taking unit and/or a sample fluid purification device. For example, the microfluidic system may comprise an indicator for indicating the presence of an adequate minimum amount of a sample fluid in the front-end unit to a user.

In one embodiment, the passive pressure valve comprises a surface wettability barrier, that is, an area having a different, and, in particular, lower wettability than a surrounding surface. The surface wettability barrier is, for example, a hydrophobic barrier when the fluid is a polar fluid.

In one embodiment, the passive pressure valve comprises a geometrical wettability barrier, e.g. a geometrical fluid surface pinning barrier. For example, the geometrical wettability barrier may comprise an edge of a wall having a half opening angle above 90°. In particular, the barrier may comprise edges of opposite walls, each edge having a half opening angle above 90°. If a fluid meniscus reaches a geometrically defined edge with a half opening angle above 90°, its contact angle to the wetted surface is no longer fixed. As long as no driving pressure is applied, the meniscus is fixed or pinned to the edge with zero capillary pressure. Thus, the pinning effect may be used to control the filling behavior of the reservoir. A liquid front is fixed at the pining barrier, until a breakthrough pressure is reached or another liquid front reaches the barrier from the opposite direction and combines with the fixed one.

In one embodiment, a part of the first passage, which is downstream of the common part of the first and second passages, comprises a passive pressure valve. Thereby, complete filling of the reservoir up to the passive pressure valve may be facilitated. A breakthrough pressure of the passive pressure valve may be sufficiently low in order to ensure that the capillary channel may still be filled substantially by capillary force. If fluid is received under a too high pressure, the passive pressure valve will allow fluid to break through and reach the outlet, for example, or a further downstream part of the reservoir.

In one embodiment, an entrance of a further capillary channel may be arranged at the reservoir, the reservoir forming a third passage from the inlet to the entrance of the further capillary channel, the third passage having at least an upstream part in common with the first passage. For example, the third passage may have an upstream part in common with the first and the second passage. In one embodiment, the entrance to the first capillary channel and the entrance to the further capillary channel are separated by a passive pressure valve. This has the same advantages as explained above for the passive pressure valve present in the common part of the first and second passages concerning the entrance to the first capillary channel. In one embodiment, a series of entrances of respective further capillary channels may be arranged at the reservoir and, for example, may be separated by respective passive pressure valves. Thereby, a series of capillary channels may each be autonomously filled.

In a second aspect of the invention, a method of filling a capillary channel is provided, comprising the steps of:

receiving a fluid at an inlet of a reservoir under pressure,

letting the fluid flow into a first passage of the reservoir, which passage extends from the inlet to an outlet of the reservoir,

letting the fluid, through a second passage of the reservoir extending from the inlet to an entrance of the capillary channel, reach said entrance of the capillary channel, which entrance is arranged at the reservoir, and

reducing a pressure of the fluid at the entrance of the capillary channel by a sufficiently low hydraulic resistance of the first passage.

The reducing of the pressure is achieved by the structure of the reservoir. In particular, the pressure is reduced without active pressure reducing means.

For example, the second passage has at least an upstream part in common with the first passage. The fluid reaching the entrance of the capillary channel may enter the capillary channel. For example, the capillary channel is filled by capillary force.

These and other aspects of the invention will be apparent from and illustrated with reference to the embodiments described hereinafter.

### BRIEF DESCRIPTION OF THE DRAWINGS

FIG. 1 illustrates an exemplary construction of a reservoir and a capillary channel of a microfluidic system according to the present invention.

FIG. 2 is a diagram illustrating the microfluidic device of FIG. 1.

FIG. 3 illustrates an alternative embodiment of the microfluidic device having a filter.

FIG. 4 is a diagram illustrating the microfluidic device of FIG. 3.

FIG. 5 is a further embodiment of the microfluidic device with a filter.

FIGS. 6 to 8 illustrate the filling of the capillary channel of a further embodiment of the microfluidic device with hydrophobic surface wettability barriers.

FIG. 9 illustrates a further embodiment of a micro fluidic device having a geometrical wettability barrier.

FIG. 10 is a schematic sectional view of a further embodiment of the microfluidic device with a debubbling chamber.

### DETAILED DESCRIPTION OF EMBODIMENTS

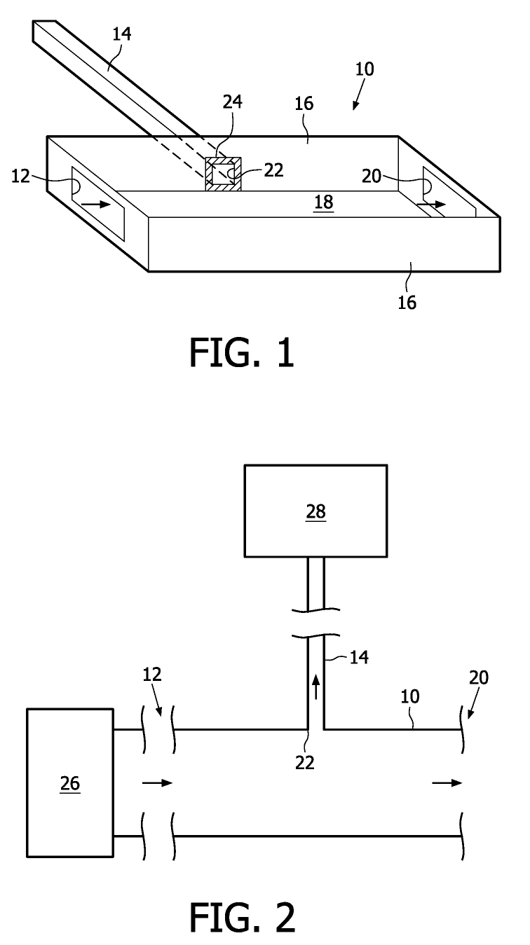

In FIG. 1, the geometrical construction of a reservoir 10 interfacing an inlet 12 to a capillary channel 14 of a microfluidic system is illustrated schematically. The reservoir 10 has a rectangular cross-section with sidewalls 16 and top and bottom walls 18. In FIG. 1, the top wall is not shown for illustrative purposes.

The inlet 12 is arranged in a front wall of the reservoir 10. An outlet 20 is arranged in a back wall of the reservoir 10. For example, the inlet 12 and the outlet 20 have respective cross-sections, which are smaller than the cross-section of the reservoir 10. The inlet 12, for example is connected to a front-end module for sample fluid capture or purification. The sample fluid is received by the reservoir 10 at the inlet 12 and begins to fill the reservoir 10.

In one sidewall 16, an entrance 22 of the capillary channel 14 is arranged. The inner walls 16, 18 of the reservoir 10, including an area 24 surrounding the entrance 22, have a substantially uniform wettability. For example, the sample fluid is an aqueous fluid having a certain contact angle with the walls of the reservoir 10. The capillary channel 14 is designed to allow transporting the fluid by capillary force.

When the reservoir 10 is filled up to the entrance 22, the fluid will be in contact with and wet the entrance 22. Any sample fluid surplus leaves the reservoir 10 via the outlet 20.

The cross-section of the capillary channel 14 is much smaller than the cross-section of the reservoir 10 perpendicular to the fluid flow direction from the inlet 12 to the outlet 20. Because of the negligible hydraulic resistance of the reservoir with respect to the hydraulic resistance of the capillary channel, a fluid received under pressure will flow past the entrance 22 rather than enter the capillary channel 14 under pressure. Thus, the low hydraulic resistance of the reservoir 10 effects a pressure reduction. This prevents pressurized fluid from entering the capillary channel 14. Thus, the entrance 22 of the capillary channel is wettable by an unpressurized fluid from the reservoir. Therefore, the capillary channel 14 is autonomously filled by capillary force only.

FIG. 2 schematically illustrates the microfluidic system incorporating the reservoir 10 and capillary channel 14 of FIG. 1. Arrows indicate a fluid flow from a front-end unit 26 through the inlet 12 into the reservoir 10, from the reservoir 10 through the entrance 22 and through the capillary channel 14 to a microfluidic device 28, and from the reservoir 10 out of the outlet 20. For example, a flow of the fluid from the front-end unit 26 to the inlet 12 of the reservoir 10 may be pressure driven. The microfluidic device 28 comprises, for example, a sensor or analyzing means for performing chemical, optical or other measurements on the fluid.

As can be seen in FIGS. 1 and 2, the reservoir 10 forms a first passage from the inlet 12 to the outlet 20 having a uniform cross-section. The outlet 20 is, for example, vented to the outside. Furthermore, the reservoir forms a second passage from the inlet 12 to the entrance 22 of the capillary channel 14. In this example, the second passage coincides with an upstream part of the first passage. In this example, the first passage, in particular a rear part of the first passage extending between the entrance 22 and the outlet 20, has a hydraulic resistance that is sufficiently low to provide a pressure reduction at the entrance 22 when a fluid is received at the inlet 12 under pressure. Within certain pressure limits, which may be ensured by the front-end unit 26, the reservoir 10 even provides a pressure decoupling of the entrance 22 from the inlet 12. Thus, the reservoir 10 is a pressure decoupling chamber.

Although the reservoir 10 forms a channel from the inlet to the outlet, this channel is not a microfluidic channel, and there will be no capillary transport of fluid from the inlet 12 to the outlet 20. Because the hydrodynamic resistance of a channel strongly depends on the cross-sectional dimensions, the cross-sectional dimensions of the reservoir 10 and of the capillary channel 14 may easily be adapted in order to provide that the hydrodynamic resistance of the reservoir 10 is negligible with respect to the hydrodynamic resistance of the capillary channel 14.

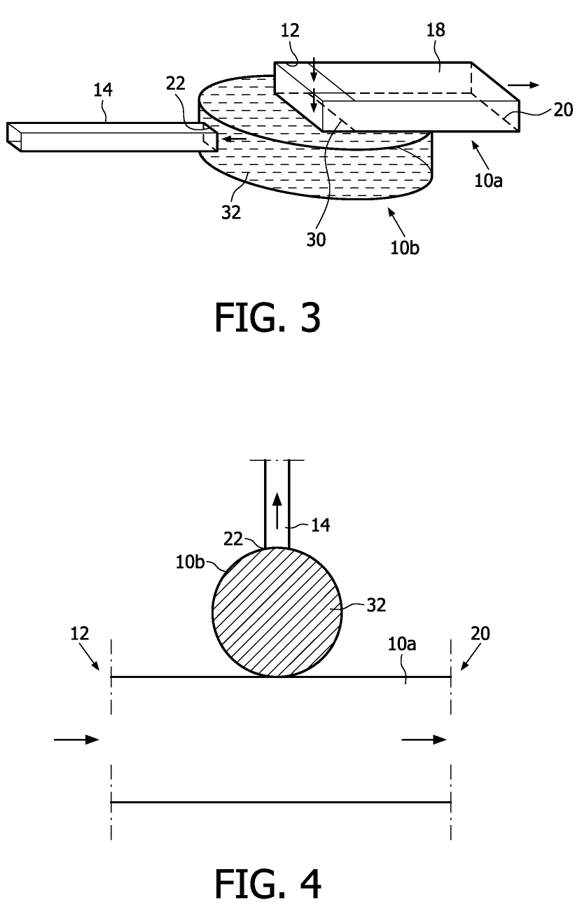

FIG. 3 shows an embodiment of the microfluidic system where the reservoir 10 comprises a first part 10a arranged on top of a second part 10b. The first part 10a of the reservoir 10 forms a first passage from an inlet 12, which is arranged in a top wall 18 at one end of the first part 10a, to the outlet 20, which is arranged at a rear wall of the first part 10a. The first passage has a rectangular cross-section.

The second part 10b of the reservoir 10 is connected to the first part 10a through a rectangular opening 30 opposite the inlet 12. The second part 10b has a cylindrical shape, the rectangular opening 30 being arranged in a top wall of the second part 10b. The entrance 22 of the capillary channel 14 is arranged in a sidewall of the second part 10b.

The second part 10b of the reservoir 10 is filled with a porous filter material 32 of a filter. The reservoir forms a second passage from the inlet 12 through the first part 10a and through the opening 30 and through the filter material 32 to the entrance 22 of the capillary channel 14. The first passage and the second passage have, at their respective upstream beginnings, a short part in common.

The filter material 32 increases the hydraulic resistance of a downstream part of the second passage from the rectangular opening 30 towards the entrance 22. The comparatively low hydraulic resistance of the first passage from the inlet 12 to the outlet 20 along the first part 10a of the reservoir thus provides a pressure decoupling of the entrance 22, when a fluid is received under pressure at the inlet 12. Thus, the reservoir 10 is a pressure decoupling chamber for decoupling an input pressure from the capillary flow in the capillary channel 14.

The filter material 32, due to its porous structure, is an excellent fluid absorber. Thus, fluid entering the second part 10b through the opening 30 will be transported to the entrance 22 of the capillary channel. The entrance 22 of the capillary channel is wettable by an unpressurized fluid from the reservoir, in particular, from the reservoir part filled by the filter material 32.

FIG. 4 schematically illustrates the fluid circuit of FIG. 3. The first part 10a of the reservoir forms a first passage from the inlet 12 to the outlet 20, and the upstream part of this first passage coincides with a second passage from the inlet 12 through the filter material 32 of the filter in the second part 10b of the reservoir to the entrance 22 of the capillary channel. Due to the filter, the circuit is especially suitable for small pressure driven flows.

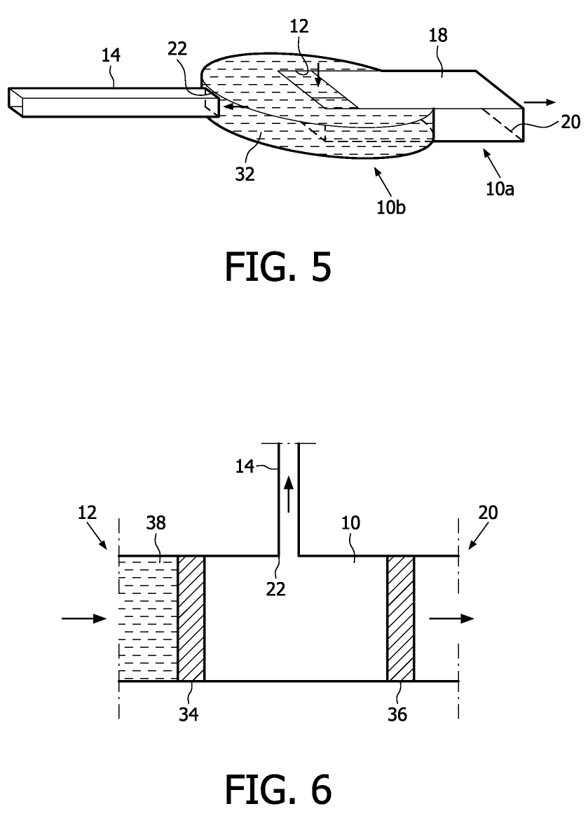

FIG. 5 illustrates a further embodiment similar to that of FIG. 3. However the first part 10a forming the first passage from the top inlet 12 to the outlet 20 in a rear wall forms a cavity in the filter material 32 of the second part 10b of the reservoir. Fluid received at the inlet 12 and flowing along the cavity will wet the filter material 32 at the sidewalls and a rear wall of the cavity. The filter material 32 will be wetted until it is saturated, and the fluid will wet the entrance 22 of the capillary channel 14. Excess fluid will simply flow past the filter material 32 along the first passage towards the outlet 20. As in FIGS. 3 and 4, the first passage leading from the inlet 12 to the outlet 20 and the second passage leading from the inlet 12 to the entrance 22 of the capillary channel 14 have an upstream part in common. As in FIGS. 3 and 4, the filter material 32 separates the first passage from the entrance 22.

In the embodiment of FIG. 5, the first passage, the second passage and the capillary channel 14 lie in one plane, and, for example, have a common level of the respective top walls. Thus, the structure may simply be produced by forming the reservoir 10 and the capillary channel 14 in a base, e.g. a base plate, and covering the base plate with a top plate forming the top walls and comprising the inlet 12. For example, the base plate is made of a plastics material. Alternatively, the base may be made of various kinds of matters, such as aluminum, copper, or ion; of silicon; or of glass. Furthermore, the base may be a printed circuit board etc. The top plate may be made of the same material as the base, or of a different material.

Alternatively to the structure of FIG. 5, the first part 10a of the reservoir may also be formed in the substrate or base without forming a cavity in the filter material 32. For example, the first part 10a may be arranged at a side of the second part 10b of the reservoir opposite to the entrance 22 or at a different side position. A disk shaped or cylindrical filter material 22 that contains no cavity is easier to manufacture.

FIGS. 6 to 8 show a further embodiment of a microfluidic system having a reservoir 10 and a capillary channel 14 similar to those of FIG. 2. However, a first hydrophobic surface wettability barrier 34 is arranged in the upstream, common part of the first and second passages. A second hydrophobic surface wettability barrier 36 is arranged in the downstream part of the second passage leading to the outlet 20. The barriers 34, 36 form hydrophobic stops, which form passive pressure valves. In the areas 34 and 36 of the inner walls of the reservoir 10, the surface energy is different compared to the surrounding of the inner walls of the reservoir 10.

For example, the barriers 34 and 36 may be formed by hydrophobic surface areas of the bottom wall and the top wall of the reservoir 10. The barriers 34, 36 may be produced as follows. Initially, the whole surface of the reservoir walls is treated by a surface treatment method in order to hydrophilize the surface. The surface treatment method is, for example, a plasma, absorption, or chemical method or any other method known in the art. Then, hydrophobic areas are prepared, e.g., by brushing a polymer coating such as a teflon coating onto the respective parts of the walls. This results in surface wettability barriers, which are based on different surface energies.

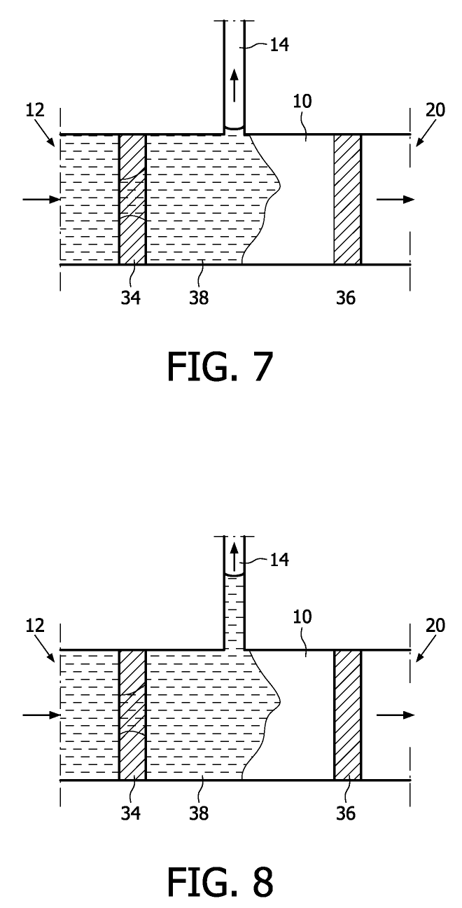

A fluid 38 received at the inlet 12 will first wet that part of the reservoir 10 upstream of the first barrier 34, which blocks the fluid. At a certain breakthrough pressure of the fluid, a breakthrough is realized, as is shown in FIG. 7, and the fluid can pass the first barrier 34.

The fluid may now flow further along the second passage and wet the entrance 22 of the capillary channel, which is located between the barriers 34 and 36. The entrance 22 of the capillary channel is wettable by an unpressurized fluid from the reservoir. Thus, the capillary channel 14 may be filled autonomously, as is shown in FIG. 8. For example, the fluid may fill the reservoir up to the second barrier 36. The second barrier 36 may require the same, a lower, or a higher breakthrough pressure as compared to the first barrier 34. The breakthrough pressure is, e.g., low enough not to influence the filling of the capillary channel.

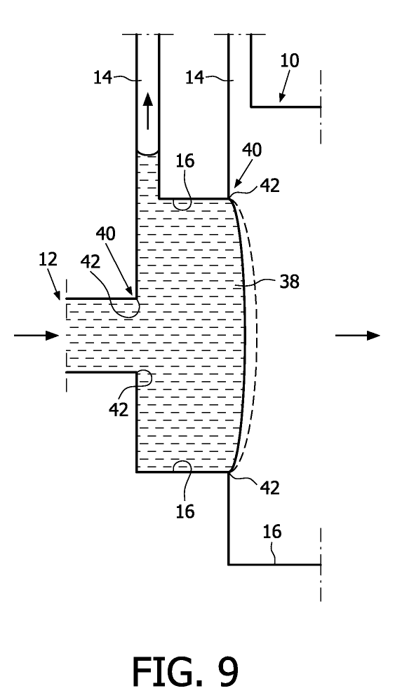

FIG. 9 shows a further embodiment of a microfluidic system having a reservoir similar to that of FIG. 2. However, two capillary channels 14 are arranged at sidewalls 16 of the reservoir 10. Whereas in FIG. 6, a passive pressure valve is formed by a surface wettability barrier 34, in FIG. 9, passive pressure valves are formed by geometrical wettability barriers 40.

Each geometrical wettability barrier 40 is formed by edges 42 formed in opposing walls, e.g. sidewalls 16, of the reservoir 10. The edges 42 have a half opening angle larger than 90°. As is shown in FIG. 9, a meniscus of the fluid 38 is fixed or pinned to the edges 42. This pinning effect is used to control the wetting behavior of the reservoir 10. The fluid is fixed at the barrier 40 with zero capillary pressure, until a breakthrough pressure is reached. The entrance 22 of the capillary channel is wettable by a substantially unpressurized fluid from the reservoir. The breakthrough pressure is, e.g., low enough not to influence the filling of the capillary channel.

As is shown in FIG. 9, a first sidewall 16 has a saw tooth structure comprising an entrance to a respective capillary channel 14 on each tooth. Because of the pinning effect of the geometrical wettability barriers, a series of capillary channels 14 may be autonomously filled one after the other.

The barriers of FIGS. 4 to 8 and 9 enable a void-free filling of capillary channels by ensuring that a sufficient amount of fluid is present in the reservoir in front of a barrier, before filling of the capillary channel is started. Thus, an autonomous and void-free filling of a capillary channel is achievable. Thus, the filling of the capillary channel does not depend on the rate of user actions, within certain limits. For example, even if enough sample fluid is collected in a sample taking unit for supplying the fluid to the inlet 12, for example, a slow compression of a fluid collecting means such as is swap by the user may lead to slow fluid feeding. This could lead to a shortage of fluid, if the autonomous filling was triggered too early. The reservoir comprising a passive pressure valve may prevent a too early triggering of the autonomous filling.

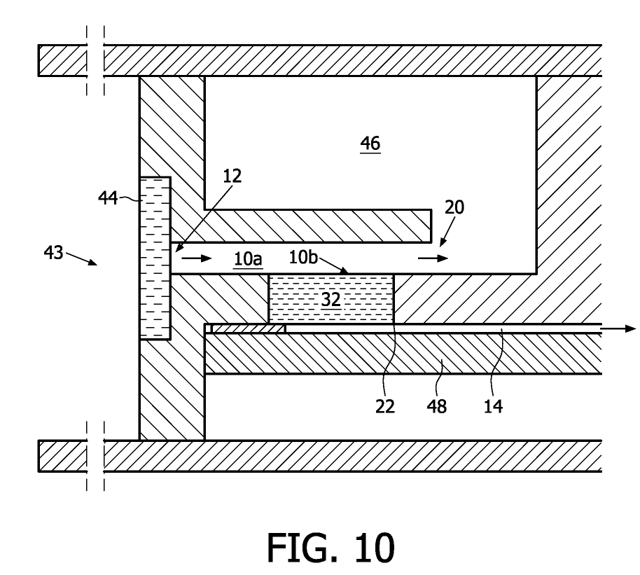

FIG. 10 shows a part of a hand-held apparatus comprising a microfluidic system according to the invention, which is similar to that of FIG. 4. For example, the hand-held apparatus is a hand-held device for analyzing a fluid collected with a swab. For example, the fluid is saliva. In order to release the saliva from the swab, force is needed. For example, the swab is pressed to release the saliva in a receiving opening 43 on the left side of the cylindrical apparatus in FIG. 10. The fluid is filtered by a first filter 44 and enters a reservoir 10 through the filter 44. Thus, the filter 44 is placed at the inlet 12 of the reservoir. Since the fluid is released by pressure from the swab, the fluid is received at the inlet 12 under pressure. At an opposite end of the reservoir 10, an outlet 20 to a waste chamber 46 is arranged. Thus, a first part 10a of the reservoir 10 forms a first passage from the inlet 12 to the outlet 20. Due to a large cross-section of this first passage, the pressure of the fluid is reduced. While the first part 10a of the reservoir 10 has a homogenous cross-section along the first passage, a second part 10b of the reservoir 10 is arranged next to the first part in a sidewall of the first part 10a. The second part 10b is filled with a filter material 32 of a filter. The filter material 32 separates the first passage from an entrance 22 of a capillary channel 14 formed between the outer wall of the first part 10a of the reservoir and a substrate or base 48, in which the capillary channel 14 is formed. The filter material 32 is, for example, a porous and hydrophilic material, so that it is easily saturated with an aqueous fluid. For example, the filter is a glass fiber pad.

Because of the low hydraulic resistance of the first part 10a of the reservoir, and because of the comparatively high hydraulic resistance of the filter material 32 in the second part 10b of the reservoir, the pressure at the entrance 22 of the capillary channel 14 is decoupled from the pressure at the inlet 12. Therefore, the capillary channel 14 will be autonomously filled by the fluid.

Furthermore, bubbles, which may be contained in the fluid received at the inlet 12, will pass the filter material 32 and will leave the reservoir 10 at the outlet 20 to the waste chamber 46. Thus, the reservoir 10 is a pressure decoupling chamber as well as a debubbling chamber. Since the entrance of the capillary channel is completely separated from the first passage of the reservoir, it is ensured that no bubbles will reach the entrance 22. Furthermore, the homogenous cross-section of the first part 10a of the reservoir forming the first passage from the inlet 12 to the outlet 20 to the waste chamber 46 ensures a continuous passage for gas bubbles to the waste chamber.

For example, the filter material 32 may additionally be impregnated with at least one substance, for example a chemical substance, for dissolving the substance in the fluid passing the filter material.

The reservoir 10 forms a second passage from the inlet 12 through the filter material 32 to the entrance 22 of the capillary channel. Because the first passage and the second passage have a common upstream part, it is ensured that a certain amount of fluid is present in the reservoir 10 when the fluid reaches the filter material 32. This facilitates a void-free filling of the capillary channel 14, and the filling process is not dependent on the rate of the user's actions or on the quantity of the administered sample fluid.

Because wetting of the entrance 22 of the capillary channel 14 is ensured, when the reservoir 10 is filled, the filling of the capillary channel 14 may be independent of the orientation of the micro fluidic system. When the micro fluidic system is a part of a hand-held device, thus, the result of an analysis performed by a microfluidic device, which is filled via the capillary channel 14, does not depend on the way the hand-held device is held.

While the invention has been illustrated and described in detail in the drawings and foregoing description, such illustration and description are to be considered illustrative or exemplary and not restrictive. The invention is not limited to the disclosed embodiments.

The microfluidic system of the invention may be applied in various systems and processes, for example microfluidic systems for DNA analysis (e.g., polymerase chain reaction and high-throughput sequencing), proteomics, inkjet printers, blood-cell-separation equipment, biochemical assays, chemical synthesis, genetic analysis, drug screening, electrochromatography, surface micromachining, laser ablation, and the immediate point-of-care diagnosis of diseases.

Variations to the disclosed embodiments can be understood and effected by those skilled in the art in practicing the claimed invention, from a study of the drawings, the disclosure, and the appended claims. Furthermore, all the disclosed elements and features of each disclosed embodiment of the microfluidic system or the method can be combined with, or substituted for, the disclosed elements and features of every other disclosed embodiment of the microfluidic system or the method, except where such elements or features are mutually exclusive. The mere fact that certain measures are recited in mutually different dependent claims does not indicate that a combination of these measures cannot be used to advantage.

In the claims, the word “comprising” does not exclude other elements or steps, and the indefinite article “a” or “an” does not exclude a plurality. Any reference signs in the claims should not be construed as limiting the scope.

1. Microfluidic system, comprising:
an inlet (12) for receiving a fluid,
a capillary channel (14),
an outlet (20) for letting excess fluid out, and
a reservoir (10) for interfacing the inlet (12) to the capillary channel (14),
wherein the reservoir (10) forms a first passage from the inlet (12) to the outlet (20),
wherein the reservoir (10) forms a second passage from the inlet (12) to an entrance (22) of the capillary channel (14), and
wherein a hydraulic resistance of the first passage is sufficiently low in order to effect a pressure reduction at the entrance (22) of the capillary channel (14) when a fluid is received under pressure at the inlet (12).

2. Microfluidic system as claimed in claim 1, wherein a hydraulic resistance of the first passage is lower than a hydraulic resistance of the second passage and the capillary channel (14).

3. Microfluidic system as claimed in claim 1, wherein the pressure reduction allows filling the capillary channel (14) substantially by capillary force.

4. Microfluidic system as claimed in claim 1, wherein the entrance (22) of the capillary channel (14) is wettable by a fluid from a common part of the first and second passages.

5. Microfluidic system as claimed in claim 1, wherein an inner surface area (24) of the reservoir (10), which surrounds and forms the entrance (22) of the capillary channel, has a substantially uniform wettability.

6. Microfluidic system as claimed in claim 1, wherein a filter material (32) separates the first passage from the entrance (22) of the capillary channel (14).

7. Microfluidic system as claimed in claim 1, wherein the first passage is passable by bubbles contained in the fluid.

8. Microfluidic system as claimed in claim 1, wherein a common part of the first and second passages comprises a passive pressure valve (34; 40).

9. Microfluidic system as claimed in claim 8, wherein the passive pressure valve comprises a surface wettability barrier (34).

10. Microfluidic system as claimed in claim 8, wherein the passive pressure valve comprises a geometrical wettability barrier (40).

11. Microfluidic system as claimed in claim 1, wherein a part of the first passage, which is downstream of the common part of the first and second passages, comprises a passive pressure valve (36; 40).

12. Method of filling a capillary channel, comprising the steps of:
receiving a fluid at an inlet (12) of a reservoir (10) under pressure,
letting the fluid flow into a first passage of the reservoir (10), which passage extends from the inlet (12) to an outlet (20) of the reservoir (10),
letting the fluid, through a second passage of the reservoir (10) extending from the inlet (12) to an entrance (22) of the capillary channel (14), reach said entrance (22) of the capillary channel (14), which entrance (22) is arranged at the reservoir (10), and
reducing a pressure of the fluid at the entrance (22) of the capillary channel (14) by a sufficiently low hydraulic resistance of the first passage.
